(19) United States
(12) Patent Application Publication
(10) Pub. No.: US 2005/0005161 A1
(43) Pub. Date: Jan. 6, 2005

(54) Services and secure processing environments

(76) Inventor: Adrian Baldwin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/884,114

(22) Filed: Jul. 2, 2004

(30) Foreign Application Priority Data
Jul. 4, 2003 (GB) 0315644.5

(51) Int. Cl. H04L 9/00

(52) U.S. Cl. 713/200; 713/175

(57) ABSTRACT

There is disclosed a secure processing environment comprising a processor, at least one memory containing operating code, and a communications interface. The processor when running the operating code is adapted only to accept executable code for services, to be run by the processor in response to requests received through the communications interface, through the communications interface by means of a secure loading process. Data structures involved in connection with loading such code are disclosed, as are communication methods for providing such code. Methods of manufacturing and initialising such a secure processing environment are also discussed.

### FIELD OF INVENTION

The present invention relates, in its different aspects, to secure processing environments, provision of services using secure processing environments, interaction between service providers, users, and secure processing environments, and to manufacture and initialisation of secure processing environments.

### DESCRIPTION OF PRIOR ART

A secure processing environment contains a processor and memory separate from the main central processing unit (CPU) of a computing device, and is adapted so that interested parties can have confidence that it has not been compromised. Typically, such an environment will have its own clock and battery, and will also contain tamper protection hardware. Products of this type are produced by Hewlett-Packard, IBM and n-cypher.

Such environments are typically provided with an installed service, and are used for providing this service in a trusted or trustworthy manner. There is a growing desire for service providers (SPs) to provide services to users using such secure processing environments, so that users can have confidence in a chain of trust back to a generally trusted party.

### SUMMARY OF INVENTION

In a first aspect, the invention provides a secure processing environment comprising a processor, at least one memory containing operating code, and a communications interface, wherein the processor when running the operating code is adapted only to accept executable code for services, to be run by the processor in response to requests received through the communications interface, through the communications interface by means of a secure loading process.

Preferably, the at least one memory contains a certificate provided by the manufacturer of the secure processing environment warranting that the secure processing environment is a secure processing environment.

In a further aspect, the invention provides a data structure comprising a request for a certificate from a service provider in respect of a service to be run on a secure processing environment, the data structure comprising: an identifier for the service; a public key for the service provided by the secure processing environment; and an extension field containing information specific to the service and digitally signed by the secure processing environment.

In a further aspect, the invention provides a data structure comprising a certificate from a service provider in respect of a service to be run on a secure processing environment, the data structure comprising a certificate with the following elements: an identifier for the service; a public key for the service provided by the secure processing environment; and an extension field containing information specific to the service and digitally signed by the secure processing environment; the certificate being signed by a private key of the service provider.

The extension field advantageously contains one or more of: the identifier for the service and the result of a one-way function carried out on application code for the service; the public key for the service provided by the secure processing environment; and either a certificate provided by the manufacturer of the secure processing environment warranting that the secure processing environment is a secure processing environment or a reference to such a certificate.

Such data structures may be carried by information carrying signals, or may be stored on recordable media, which may include computer memories.

In a further aspect, the invention provides a method of manufacturing and initialising a secure processing environment, comprising: manufacturing and testing a circuit board assembly, comprising a processor, at least one memory and a communications interface, of a secure processing environment; providing tamper protection for the secure processing environment; receiving from the secure processing environment a public key for the secure processing environment; and providing and digitally signing a certificate for the secure processing environment, the certificate including a device name and the public key.

In a still further aspect, the invention provides a method for a service provider (SP) to communicate with a computer node, the method comprising the steps of the service provider receiving a certificate request from the computer node, which certificate request includes or references a certificate of a secure processing environment (SPE) associated with the computer node, the service provider validating the certificate of the SPE and, if validated, providing a service to the computer node.

By receiving and validating the SPE certificate the SP can verify that the SPE is trustworthy and be confident that it will use delegated trust responsibly, for instance in interactions with third parties or use of services provided to it from the SP.

Suitably, the service provider receives a service request from the computer node, requesting the provision of a service.

Suitably, the SP provides a trust token to the SPE. Suitably, the trust token comprises a certificate signed by the SP and including a part of the certificate request generated and signed by the SPE.

In subsequent operations the SPE (and thus to some extent the computer node of a user) can use the trust token from the service provider with third parties as a trust certificate. The SPE can show that it has trust from a specified party.

Suitably, the certificate request comprises a signed reference to the SPE certificate. Suitably, the SPE generates a public/private key pair and the computer node communicates the public key thereof to the SP in the form of a certificate request. Suitably, the certificate request comprises a service identifier for the service requested. Suitably, the certificate request comprises a hash of the service identifier. Suitably, the SP provides a hash of the service application data to the SPE and the certificate request comprises the hash of the service application data. Suitably, the hash of the service application data provided by the SP is signed. Suitably, the hash of the service application data in the certificate request is signed.

Suitably, the certificate request is signed by the SPE.

Suitably, the service is a service to be executed on the computer node. Suitably, the SP communicates to the SPE initial conditions relating to the service including one or more of a period for which the service can operate and a permitted number of operations of the service. Suitably, the SPE terminates the service when the initial conditions are met.

Suitably, the service application data is communicated to the computer node which compares a hash of the service application data with a hash of the service application data received from the SP to validate the service application data.

### BRIEF DESCRIPTION OF DRAWINGS

The present invention will now be described, by way of example only, with reference to the drawings that follow; in which:

FIG. 1 is a schematic functional illustration of a service provision communication network.

FIG. 2 is a schematic illustration of a user's computer node.

FIG. 3 is a functional flow diagram illustrating operation of the present invention.

FIG. 4 is a communication diagram showing sequentially the communications occurring between a user and a service provider according to the method of FIG. 3.

FIG. 5 is a schematic illustration of a certificate request token.

FIG. 6 is a functional flow diagram illustrating the manufacturer's certification of a SPE

FIG. 7 is the basic firmware architecture for the SPE.

FIG. 8 Shows the trust relationships created by the certificate structures created by service providers, the SPE and the manufacturer of the SPE

### DESCRIPTION OF SPECIFIC EMBODIMENTS

Appropriate circumstances for the use of a secure processing environment will be described. After this, a preferred embodiment of a secure processing environment will itself be described, as will the processes involved in manufacturing and initialising such a secure processing environment. After this will be described a method for loading service code on to the secure processing environment—associated data structures will also be described. Finally, user interaction with the secure processing environment, and in particular with a service running on the secure processing environment, will also be described.

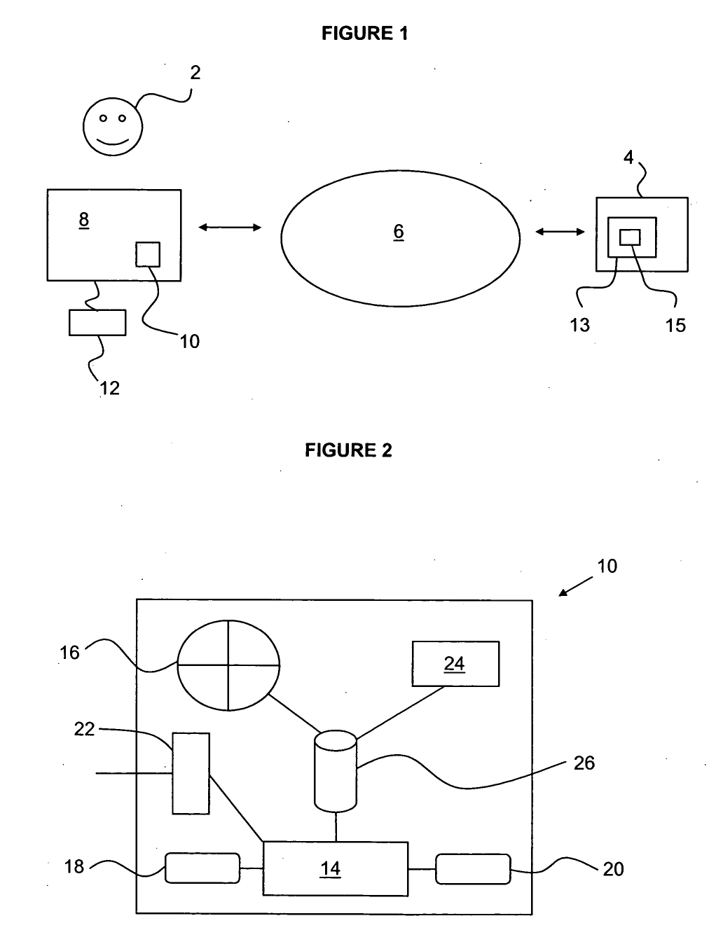

With reference to FIG. 1 of the drawings there is shown a communication network comprising a user 2, a service provider (SP) 4 and a communication network 6 enabling communication therebetween.

User 2 controls a computer node 8 comprising a secure processing environment 10, and user input/output devices indicated schematically at 12. While this may in principle be an individual user controlling a personal computer, in most practical embodiments of the present invention the computer node 8 will be a server and the user 2 will be one of a number of users having access to the server. Such a server may be used to provide services within a single enterprise, or may be used to provide services to others over the public Internet or other appropriate communications network.

SP 4 includes a service provider module 13 for providing a service to computer node 8, which service provider module incorporates a computer program 15 for executing the method set out herein.

SP 4 will most typically be a further server, and communication with computer node 8 most typically provided over the public Internet, though again any appropriate communication network could be used for this purpose, such as another form of wide area network.

Referring to FIG. 2 of the drawings that follow, the secure processing environment 10 is shown in more detail. The secure processing environment 10 comprises a processor 14, a clock 16, a volatile memory 18, a non-volatile memory 20, a communication interface 22, a tamper detection module 24 and a battery 26.

Processor 14 is a low power consumption processor for executing instructions in the memories 18 and 20 as desired. The functions that will typically need to be carried out include cryptographic processing, formatting and policy validation. Alternatively, an additional cryptographic processor (not shown) could be used to carry out cryptographic tasks—such a processor could accelerate standard cryptographic algorithms and provide random number generation in hardware.

Clock 16 is used to indicate either absolute or elapsed time and may use a specified standard, such as Co-ordinated Universal Time (UTC) or time elapsed (e.g., in seconds) since a predetermined start instant. The accuracy of the clock 14 is a matter of design choice depending on the intended use of secure processing environment 10.

Volatile memory 18 (such as general purpose RAM) is provided for fast access to required data usually when running applications and to assist the operation of processor 14. Non-volatile memory 20 maintains boot information 28 as well as a dedicated public/private key pair 30 and a digital certificate 32 for the secure processing environment 10. The public/private key pair is specific to the particular SPE 10 and is referred to as the permanent public/private key pair (and permanent public and private keys respectively). Additionally, non-volatile memory 20 includes a trust list with details of which third parties are regarded as trusted by the SPE or by services within the SPE 10 and under what conditions. The conditions may limit the time period of trust, require a certificate or other security steps. The non-volatile memory is configured such that no other device can read or alter it. Thus the public/private key pair 30 and the certificate 32 are kept confidential. As will be discussed below, it is preferred that at least some of this non-volatile memory 20 be destroyed, or the information within it destroyed, if an attempt to tamper with the SPE 10 is detected.

An alternative approach is for firmware (see below) and service code to be provided in Flash memory—preferably separate Flash memories, as any risk of contamination of the firmware should be minimised.

Software provided in the memories of the SPE is essentially firmware loaded on manufacture of the SPE. In addition to this, the permanent public/private key pair is preferably provided by the manufacturer during an initialisation process. This firmware preferably includes a secure loading routine (as will be discussed further below), a key safe (for storing public/private key pairs, typically such that these will be destroyed if tampering is detected) and associated cryptographic and key management services, trust lists (of, for example, service providers that the SPE is programmed to be prepared to accept a service from), policy handling routines, a procedure for handling messages to and from other computing entities (such as the main CPU of computer node 8, or any other computing entity in communication with computer node 8), scheduling routines and a hardware abstraction layer—this may essentially comprise a simple operating system (augmented with cryptography and key management). There may be one or more specific user applications preloaded in firmware, but there may also be none—in which case a service will have to be loaded from an SP before the SPE can provide any useful service to a user. Such a service can only be loaded by using the secure loading routine, as will be described below.

Communication interface 22 is used for the secure processing environment 10 to communicate with the rest of computer node 8.

Tamper detection module 24 is coupled to the processor 14 to indicate any attempt at tampering with or intrusion (physical or digital) into the secure processing environment 10. In conjunction with processor 14, the tamper detection module responds to unauthorised tampering or intrusion by disabling the secure processing environment 10 and, in particular, denies access to or destroys the public/private key pair 30 (and optionally any other public/private key pairs or secrets generated by the processor 14) and certificate 32. The disablement may be temporary or permanent.

The amount of tamper protection provided will depend on the level of security required, but will typically be high as the type of service provided by an SPE will be such that the SPE manufacturer, the SP (if it is their service) and the user will all have a strong interest in the service running without subversion. Tamper protection will typically involve protection from physical and electromagnetic attacks such as physical penetration, temperature changes and x-rays (encapsulation, electromagnetic screening), monitoring to detect any such attack (powered circuits hidden in encapsulation layers, detection in change of physical or electromagnetic properties of the SPE device or parts of the device, and, as indicated above, response to detection of an attack (typically destruction of sensitive and secure data). Such tamper protection can be linked to a diagnostic system to analyse failures in the SPE. The protection system should be separated as well as possible not only from anything outside the SPE, but also from the computing environment of the SPE itself (to minimise any risk of logical attacks).

Battery 26 ensures the secure processing environment 10 remains independent and provides power to the clock 16 and processor 14 (this may be only if required because of a failure or removal of an external power supply). The battery 26 typically also powers parts of the tamper detection module requiring electrical power.

In addition to executing software loaded into it, secure processing environment 10 is able to digitally sign documents and create hashes of documents.

SPEs 10 can therefore be provided with a range of capabilities, covering factors such as processor speed, memory size, cryptography support, interfaces and level of protection against attack.

Computer node 8 includes management software for interfacing with the SPE 10. As indicated below, it is preferred that the user 2, and in fact the computer node 8, are able to communicate with the SPE 10 but can only in a very limited sense be said to control it. SPE 10 is an autonomous processing environment.

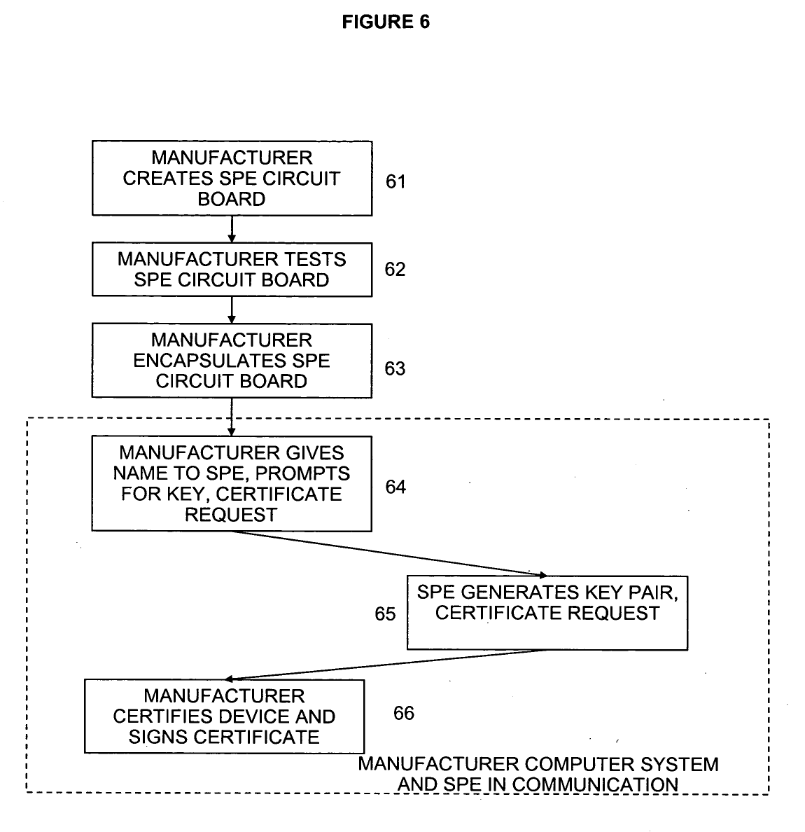

The manufacture of a preferred SPE will now be described with reference to FIG. 6. All manufacturing steps will be carried out in an environment fully controlled by the manufacturer without risk of subversion by another party. First, the circuit board of the SPE will be manufactured 61 and loaded with firmware necessary to provide the computing environment—at this point the SPE is already in effect an autonomous computing environment. The SPE is then tested 62 to ensure that it is not faulty—testing at this stage is desirable, as subsequent fabrication and processing steps will typically be expensive and should therefore not be carried out on faulty boards. Desirably, the manufacturer now has a full record of the characteristics of the device and its manufacture and its testing history. The board will then be encapsulated 63 and the physical parts of the tamper prevention for the SPE will be provided.

At this point the SPE is essentially complete, but requires initialisation by the manufacturer. The SPE is then placed in controlled communication with computing apparatus of the manufacturer (again, in such a way that outside intervention is not possible). The manufacturer sends a message 64 to the SPE, the message giving the SPE a name and prompting the SPE to generate a key and an appropriate certificate request structure.

As part of this interaction, the manufacturer would also set the clock time. (The clock then will not be alterable although additional correction factors could be applied by individual services)

The SPE does this 65, the key pair (the permanent key pair) being stored in the protected memory, and the certificate request including the name and the public key and being signed with the private key (thereby demonstrating ownership of it). The manufacturer needs to decide whether to certify the device, considering the device records, physical presence of the device and physical control of the communications path to the device (it is envisaged that in preferred circumstances it will be necessary for certification to be carried out in a secure strong room by trusted individuals). The certificate that is provided may be a standard X509v3 certificate, and includes the name of the device, its public key, validity dates and extensions (such as policies concerning reliance on the device, information concerning the level and type of protection supported, and guarantees concerning the manufacturing process). The certificate should identify the manufacturer and should identify a chain of trust leading up to a well-known and generally trusted Certification Authority. The certificate will generally also contain a validity period indicating a maximum possible lifetime for an SPE (in embodiments, it may be possible for an SPE to be renewed or recertified, possibly on the basis of an existing expiring certificate and diagnostic tests). The manufacturer signs the certificate and the certificate is included within the device.

After this stage it will only be possible, in aspects of the invention described further below, to add executable code to the SPE by using the secure loading process described further below. Moreover, after this stage it is desirable that no party (preferably not even the manufacturer) can control the SPE except to ask for its identity and to ask it to load a new service by the secure loading process or to stop providing an already loaded service. At this stage the device is ready for shipping: it has a unique identity, firmware allowing the controlled loading of a service, and is certified as being a genuine piece of trusted hardware.

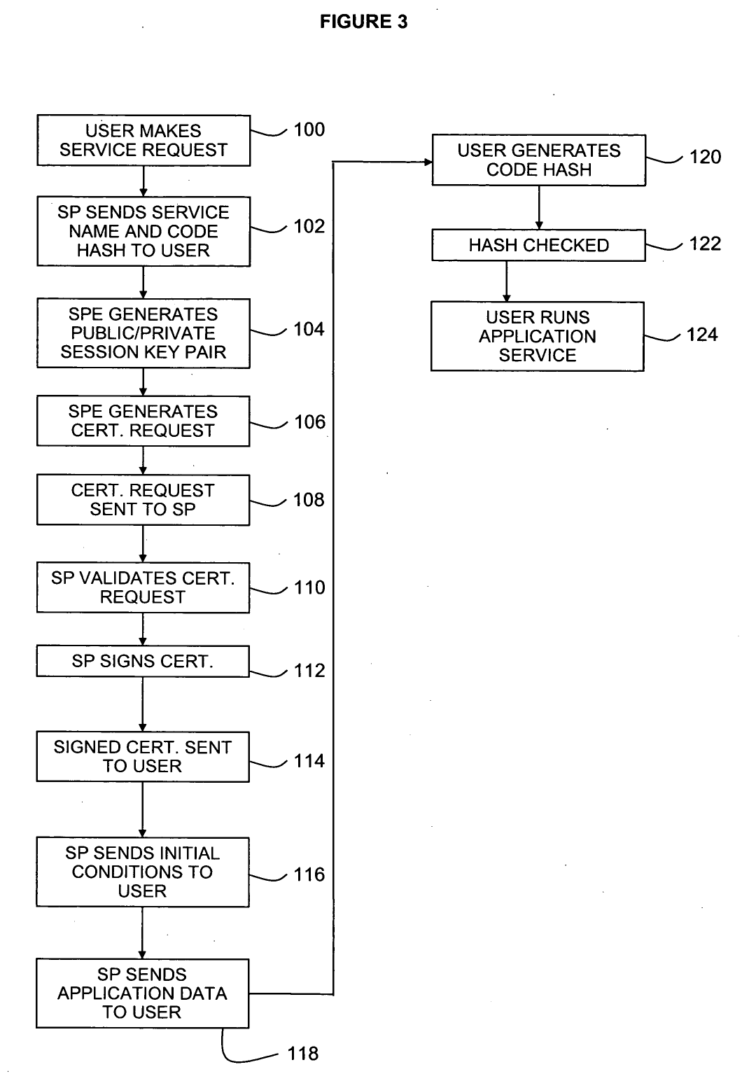

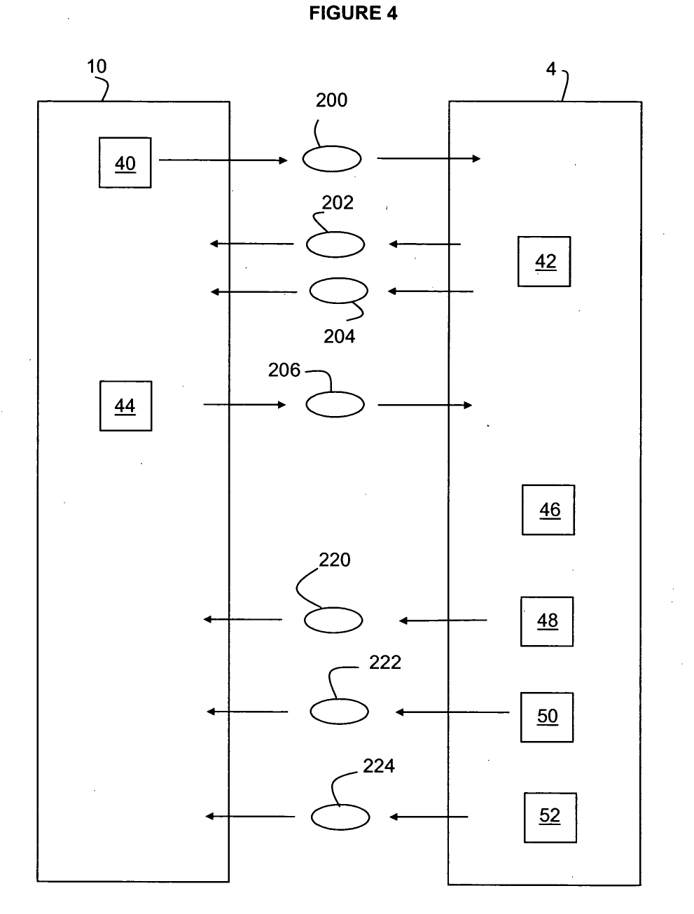

With reference to FIGS. 3 and 4 of the drawings that follow, a method of securely loading a service on to an SPE in accordance with aspects of the invention will now be described using the apparatus described above in relation to FIGS. 1 and 2. This specific model involves the SP being remote from the SPE and communicating with it over a general purpose communication network (over which neither the SPE nor the SP has control, at least in part). It will be appreciated that services can also be provided directly by an SP in charge of the SPE, the SP then being able to provide a preconfigured SPE to a user. The steps described below can be carried out equally well if the SP has physical possession of the SPE, and can be somewhat simplified as the computer node 8 is no longer required to act as an intermediary. For some services, such as the setting of the SPE to provide a trusted clock functionality, it may be desirable for user confidence for the SP to have this physical control.

FIG. 4 shows the message tokens communicated between the user's computer node (which, as will be described, will for at least some messages originate from the SPE within the user's computer node) and the SP 4. The message token generators and other operators (such as a certificate request validator) shown in the computer node 8 and SP 4 are representative of software, firmware and/or hardware generators of such message tokens and operators.

With reference to the method to be described, the user 2 wishes to obtain a service from SP 4, which service needs to be downloaded to the user's computer node 8. The SP 4 wishes to ensure that with the co-operation of the secure processing environment 10 the service is used as desired. For instance, the SP 4 may wish to ensure that the service is used only for a specified period. Generally, this will be achieved by having at least a part of the service run within the SPE itself.

Referring to FIGS. 3 and 4, in step 100 the user makes a service request 200 of the SP 4 using computer node 8 via a service request generator 40. For instance, the user may make a selection from a menu of services offered on a web-site of the SP 4. The communication is from the user's computer node 8 to the SP 4 via the communication network 6. It may be made relatively difficult to initiate the loading of a new service to a SPE 10 (perhaps by PIN protection, use of a physical button on the SPE 10 or by use of a smart card to enable the SPE 10), as this can be advantageous in preventing denial of service attacks.

In step 102 the SP 4 sends a service name 202 to the user and a signed hash (another one-way function could be used for this purpose, but there is no reason not to use a hash function as these are simple and ubiquitous) 204 of the application code of the service requested using a service name and signed hash provided by an application code generator 42 within the SP 4. The application data typically will be software code for execution by the SPE 10, more specifically by the processor 14 of the SPE. It will generally be the case that there will also be code to be executed by another processor controlled by the user—this code does not need to be controlled with the same level of security, and may be simply provided to the computer node 8 of the user in a normal manner—the process steps followed here relate to the code that needs to be provided to the SPE 10. The service name is used as an identifier of a service and therefore another identifier other than the actual name of the service can be used, though the former option is more convenient.

In step 104 the SPE 10 public/private key pair generator generates a public/private key pair for use in relation to the service requested by the user. These can be regarded as service keys for the relevant service provision and are referred to as the generated public/private key pair (and generated public and private keys respectively). The generated public/private key pair is stored in non-volatile memory 20. The SPE at this time will generate an application context for the service. The other service details may not in some embodiments be provided by the SP until this context is generated. The SPE may advantageously calculate a hash of such constraints and later verify this hash directly with the SP.

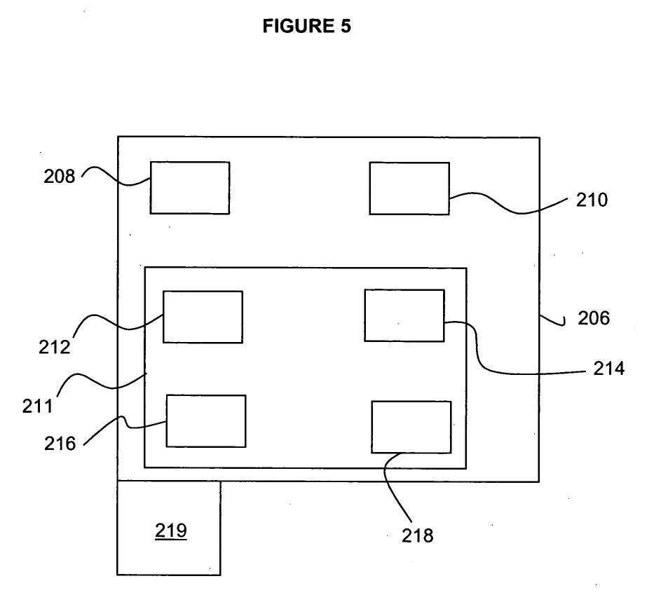

In step 106 the SPE certificate request generator 44 generates a certificate request 206, which in step 108 is communicated to the SP 4 using the generated public/private key pair. The components of the certificate request 206 are illustrated in FIG. 5 of the drawings that follow. The certificate request 206, which could be in a standard PKI format such as X509, comprising the following:

208—the service name (or other service identifier);

210—the generated service public key

211—an extension structure which itself includes

212—a hash of the service name (or other service identifier);

214—a hash of the application code for the service signed by the SP 4 (obtained in step 102 above);

216—the service public key of the SPE; and

218—the certificate, or a reference to the certificate, of the SPE.

The extension structure containing the extension elements 212 -218 is then signed with the SPE permanent private key.

The whole certificate request structure is then signed with the newly generated public key for the service. This certificate request is essentially conventional, except for the extended field 212-218 and the additional SPE signature.

This additional field desirably also includes a statement from the SPE 10 that it generated the generated key and will only let it be used with the identified application with the given hash and for a service with the given name. The additional field is signed by the permanent private key of the SPE. These elements will be used in generation of the certificate to indicate the chain of trust back to the manufacturer of the SPE.

It should be noted that while it is straightforward to implement embodiments of the invention by using an extension field to a conventional (such as x509) certificate request and certificate, it would be equally possible to use new software structures which also included the presence of a structure containing elements specific to the service concerned, the structure being signed by the permanent private key of the SPE.

In step 110 an SP 4 certificate request validator 46 validates the certificate request 206. The validation can involve (i) checking that the hash of the application code matches that sent to the user in step 102, (ii) verification of the SPE certificate 218 by checking its certification chain; and (iii) checking revocation lists to ensure the SPE certificate 218 has not been revoked.

If the signed certificate request is approved in step 110, in step 112 the SP certificate generator 48 generates a certificate for the service (as to be run on computer node 8, or at any rate with secure part run on SPE 10) including the service ID, the service public key, time limits and policies for the use of the service and the additional field signed by the SPE as provided in the certificate request.

Additionally, in step 116, in the same or a separate communication the SP 4 initial condition generator 50 generates initial conditions 222 and provides these to the user's computer node 8. The initial conditions 222 set out operating parameters and restrictions for the service to be provided (these may not, or not all, be “generated” as such—they may include general policies for use of the service). Typically these will set out some limit to the use of the service such as it can be used for a certain time period or a given number of operations. These can be used by the SPE 10 to terminate use of the service according to the instructions of the SP 4 (see below). Note that this step can be carried out at an earlier or later stage, but preferably at least after an application context has been created by the SPE. These limits should also be referred to in the certificate (either as a hash of the conditions or explicitly) allowing the SPE to tie them back to the service provider.

The user's computer node 8 is now ready to receive the service application data 224, which is communicated by SP service application data communicator 52 to the SPE 10 via user's computer node 8 in step 118. Any service code to be run by the user's computer node itself, rather than by the SPE 10, may also be provided at this time.

Having received the application data 224, in step 120 the SPE 10 generates a hash of the application data 224 and in step 122 compares this generated hash with the hash of the application data received in step 102 to verify the communication both in terms of data integrity and security.

In step 124 the service is run on the computer node 8, with the secure parts of the service run on the SPE 10—this will be discussed further below.

It will be appreciated that although the method set out above involves steps presented in a particular order, the present invention is not limited by the order set out above, except as is required for proper operation of the invention.

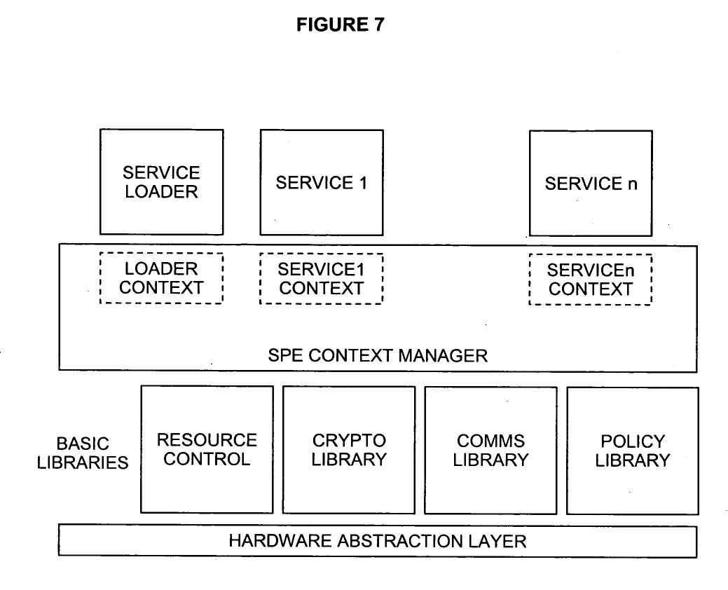

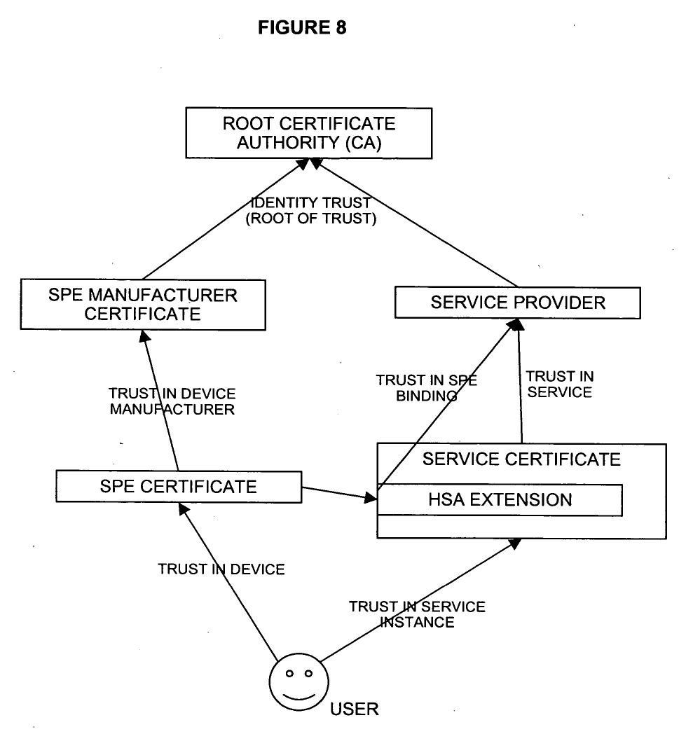

The state of the SPE 10 with the service loaded can now be considered. The software architecture of the SPE 10 is shown in FIG. 7. As described above, this contains a basic hardware abstraction layer and a number of libraries: the resource control library includes scheduling and memory allocation functions, ensuring a strict separation between the service loader and each of the applications; the other libraries provide basic support functions, such as cryptographic processes, messaging and communications, and policy handling.

The context manager is central to the system, and all the applications sit over it. Each application is provided with its own context, contained within protected memory and used to store all valuable data (particularly keys). Each item within the context manager should have policies associated with usage. It is preferred that each item be associated with a set of functions that can be performed, with policies set on functions or groups of functions. For example, the private key associated with the identity of the SPE may be associated only with encrypt and decrypt functions (hence it will not leave the protected memory under any circumstances). Other items than keys can be governed in this way—for example, a usage counter may have a policy allowing it to be incremented, the policy perhaps also including termination conditions and the possibility of change by some protocol linked with the relevant service provider. In essence, the design of the SPE is intended to enforce constraints that will protect against failures (or compromise) at the level of individual services. The user can therefore for an individual service reasonably place their trust in the service provider and SPE manufacturer combination (without having to be concerned about what other service may be loaded on to the SPE).

For an individual service, the context could include the following information:

```
Service Name;
  Application {
    Name - Application name
      Provider - Writer of application
      App Hash - the (signed) hash of the application for the service
      }
    Public, Private Key Pair - The main public private key pair for the
    service
    Certificate - The certificate identifying the service
    [Trust list] - A list of trusted public keys, or certificate hashes and
    associated purposes (essentially any information associated with
    trusting of information from certain places or with allowing control
    of information by nominated persons)
    [Key list] - A list of encrypted auxiliary key pairs, usages and
    limitations - Some applications will create extra keys (e.g., for
    encryption)
    [Condition var] - e.g., expiry date, start date, counters aiding the
    control of service delivery
```

It will of course be noted from the above that an SPE 10 of this type is capable of supporting multiple services, with individual services being provided by different Service Providers. It may also be the case that the SPE 10 is adapted to provide multiple service threads, involving services from a single Service Provider or even multiple Service Providers, at the same time.

Although this embodiment of the present invention is described in relation to the provision of a service to be run on the computer node 8, the provision by SP 4 of the service certificate as a trust token to the SPE 10 is itself a service to the user 2 as this trust token can be used by the computer node 8 with third parties to indicate a trusted third party level of trust in the SPE 10. The initial conditions provided to SPE 10 can ensure that this trust token is not abused by SPE 10.

A user of the service run on computer node 8 may be able to inspect this certificate, from which they can see two chains of trust—a chain of trust to the service provider SP, and a chain of trust to the SPE manufacturer, both of these chains can be verified by use of the requisite public keys. A user of the service can then make a decision as to whether this combination of manufacturer and service provider is one that they choose to trust. Such trust derives from the certificate chain for the SPE and the service, and also from the linkage provided by the SPE extension field, which binds the two in providing a guarantee that the service is being run within an SPE environment.

The running of a service in the computer node 8, with a secure part of the service running in SPE 10, will now be discussed. The loaded service will have been checked on loading to ensure that the digest of the application code matches the signed digest, and the SP signature will also be checked. This may be repeated before any running of the service. The user can communicate to the SPE that the service is to be run. It should be noted that interaction between the user (and other processors or computing environments associated with the computer node 8) and the SPE 10 is limited. Essentially the only instructions that can be given to the SPE are to prepare to load a new service through the service loader already described, to run a loaded service, to stop running a loaded and running service, and to remove a loaded service. Apart from this, the only likely interaction is for data to be passed between the computer node 8 and the SPE 10 in running the service—this is data to be acted on by the secure code and results of such action (executable code is not passed to the SPE in the process of running the service). Policy restrictions will generally be controlled by the SPE—which may, for example, cease execution of the secure code, or restrict its execution, or even destroy the secure code, in order to comply with policy made by the SP and indicated in the certificate. The service lifetime may therefore be controlled by the SPE, as well as the SPE ensuring that the secure code is indeed held securely and not provided to third parties.

A wide range of services can be provided by this approach—the considerations involved in determining whether to run a service in this way are whether the application code (or a part of the application code) for the service should be treated as secure and that it is desirable that the service run locally to the user (otherwise it may be more logical for the SP to run the service directly, with the user's computing node 8 acting merely as a terminal). One exemplary service is a secure timestamper (the service could wait for timestamping requests, parse them, format an appropriate timestamp and sign it with a service key—the timestamp could expire at a specified date). Secure storage and management of permission lists are other examples of services that may be appropriate for this use model.

1. A secure processing environment, comprising:
a processor;
at least one memory comprising operating code; and
a communications interface, wherein the processor when running the operating code is configured only to accept executable code for services through the communications interface corresponding to a secure loading process, the executable code to be run by the processor in response to requests received through the communications interface, the secure loading process comprising identifying the secure processing environment to a device providing the executable code.

2. The secure processing environment of claim 1, further comprising a protection circuit and wherein the at least one memory comprises a protected memory, wherein triggering of the protection circuit causes destruction of information stored in the protected memory.

3. The secure processing environment of claim 1, wherein the at least one memory comprises a certificate provided by the manufacturer of the secure processing environment warranting that the secure processing environment is a secure processing environment.

4. The secure processing environment of claim 1, wherein the processor has cryptographic capability and wherein the at least one memory comprises a secure processing environment key pair.

5. The secure processing environment of claim 4, wherein a private key of the secure processing environment key pair is stored only in a protected memory.

6. The secure processing environment of claim 4, wherein the processor is configured to cause generation of new key pairs for association with services to be run within the secure processing environment.

7. The secure processing environment of claim 1, further comprising a clock.

8. The secure processing environment of claim 1, further comprising a cryptographic coprocessor, and wherein the at least one memory comprises a secure processing environment key pair.

9. The secure processing environment of claim 1, wherein the processor is programmed by the operating code stored in the memory to initiate running of a service stored at least one of wholly and partly in the secure processing environment and run at least one of wholly and partly in the secure processing environment.

10. A computer readable medium storing a data structure that requests a certificate from a service provider corresponding to a service to be run on a secure processing environment, the data structure comprising:
an identifier for the service;
a public key for the service provided by the secure processing environment; and
an extension field comprising information specific to the service and digitally signed by the secure processing environment.

11. The computer readable medium of claim 10, wherein the extension field comprises the identifier for the service and a result of a one-way function carried out on application code for the service.

12. The computer readable medium of claim 10, wherein the extension field comprises the public key for the service provided by the secure processing environment.

13. The computer readable medium of claim 10, wherein the extension field comprises one of a certificate provided by a manufacturer of the secure processing environment warranting that the secure processing environment is a secure processing environment and a reference to the certificate.

14. The computer readable medium of claim 10, wherein the computer readable medium comprises an information carrying signal.

15. A computer readable medium storing a data structure for communicating information from a service provider to a secure processing environment, the data structure comprising:
a certificate from the service provider corresponding to a service to be run on the secure processing environment, the certificate comprising:
an identifier for the service;
a public key for the service provided by the secure processing environment; and
an extension field comprising information specific to the service and digitally signed by the secure processing environment, the certificate being signed by a private key of the service provider.

16. The computer readable medium of claim 15, wherein the certificate further comprises at least one of policies and restrictions for use of the service by the secure processing environment.

17. The computer readable medium of claim 15, wherein the extension field comprises the identifier for the service and a result of a one-way function carried out on application code for the service.

18. The computer readable medium of claim 15, wherein the extension field comprises the public key for the service provided by the secure processing environment.

19. The computer readable medium of claim 15, wherein the extension field comprises one of a certificate provided by a manufacturer of the secure processing environment warranting that the secure processing environment is a secure processing environment and a reference to the certificate.

20. The computer readable medium of claim 15, wherein the computer readable medium comprises an information carrying signal.

21. A method of manufacturing and initializing a secure processing environment, comprising:
manufacturing and testing a circuit board assembly, comprising a processor, at least one memory and a communications interface, of a secure processing environment;
providing tamper protection for the secure processing environment;
receiving from the secure processing environment a public key for the secure processing environment; and
providing and digitally signing a certificate for the secure processing environment, the certificate comprising a device name and the public key.

22. A method for a service provider to communicate with a computer node, the method comprising:
receiving a certificate request from the computer node, the certificate request comprising a certificate of a secure processing environment associated with the computer node, the certificate further comprising an identity of the secure processing environment;
validating the certificate of the secure processing environment; and
if validated, providing a service to the computer node.

23. The method of claim 22, further comprising providing a trust token to the secure processing environment.

24. The method of claim 23, wherein the trust token comprises a certificate signed by the service provider and a part of the certificate request signed by the secure processing environment.

25. The method of claim 22, further comprising providing a hash of the service application data to the secure processing environment, wherein the certificate request comprises the hash of the service application data.

26. The method of claim 25, further comprising signing the hash of the service application data.

27. The method of claim 22, wherein the service is a service to be executed on the computer node with at least a part of a service code to be executed in the secure processing environment.

28. The method of claim 27, further comprising communicating to the secure processing environment initial conditions relating to the service comprising at least one of a period for which the service can operate and a permitted number of operations of the service.

29. A method for a service provider to communicate with a computer node, the method comprising:
receiving a certificate request from the computer node, the certificate request referencing a certificate of a secure processing environment associated with the computer node;
validating the certificate of the secure processing environment; and
if validated, providing a service to the computer node.
